(19) United States
(12) Patent Application Publication
(10) Pub. No.: US 2017/0088674 A1
(43) Pub. Date: Mar. 30, 2017

(54) POLYMETALLOCARBOSILANE FROM ORGANIC METAL CATALYZED POLYMERIZATION AND USES THEREOF

(71) Applicant: INSTITUTE OF PROCESS ENGINEERING, CHINESE ACADEMY OF SCIENCES, Beijing (CN)

(72) Inventors: Weigang ZHANG, Beijing (CN); Min GE, Beijing (CN); Yuelong TIAN, Beijing (CN); Shouquan YU, Beijing (CN); Xiaoxu LV, Beijing (CN)

(21) Appl. No.: 15/310,951

(22) PCT Filed: Jul. 30, 2015
(86) PCT No.: PCT/CN2015/085508

§ 371 Date: Nov. 14, 2016

(30) Foreign Application Priority Data
Aug. 14, 2014 (CN) 201410398745.8
Sep. 24, 2014 (CN) 201410493930.5

(51) Int. Cl. C08G 79/00; D01F 9/10; C04B 35/571

(52) U.S. Cl. CPC C08G 79/00; C04B 35/571; D01F 9/10

(57) ABSTRACT

The present invention discloses a polymetallocarbosilane from organic metal catalysed polymerization and uses thereof, said polymetallocarbosilane has a structural formula as shown in (I).

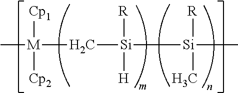

In the formula, R is methyl, ethyl, propyl, ethenyl, chloromethyl, phenyl or phenethyl; M is Ti, Zr or Hf; m is an integer equal to or greater than 1, n is an integer equal to or greater than 0, and Cp₁ and Cp₂ are each a cyclopentadienyl or substituted cyclopentadienyl group. The present invention adopts a method for producing polymetallocarbosilane by metallocene catalysed addition polymerization of an organosilane, with adjustability of metal content in polymer, simple reaction steps, mild reaction conditions and low preparation costs.

The present application claims priority to Chinese invention patent application No. 201410398745.8 filed on Aug. 14, 2014 and entitled “Polymetallocarbosilane, and preparation method and applications thereof” as well as to Chinese invention patent application No. 201410493930.5 filed on Sep. 25, 2014 and entitled “Multiphase ceramic fiber and preparation method thereof”.

### TECHNICAL FIELD

The present invention generally relates to polymetallocarbosilane and preparation method and uses thereof, and specifically to polymetallo(Ti, Zr, Hf)carbosilane and preparation method and uses thereof.

### BACKGROUND ART

SiC ceramics have excellent performances such as high strength, high modulus, high-temperature resistance, corrosion resistance, oxidation resistance, low density, high thermal conductivity, small coefficient of thermal expansion, fine wear resistance, and the like, and they find a wide range of applications in civil industries as well as in national defense areas such as aerospace, aviation, weapons, etc.

Preparation of SiC mainly includes inorganic method and organic precursor method, wherein the organic precursor method for preparing SiC mainly includes the following steps: polydimethylsilane or a six-membered ring system is prepared by condensation with alkali metal or alkaline earth metal, then the polydimethylsilane or the six-membered ring system is subjected to high temperature and high pressure treatment under a condition of 450-470° C. and 8-10 MPa in an argon atmosphere, wherein an insertion reaction occurs, CH₂ is inserted into Si—Si bond to form a polycarbosilane, the yield with respect to precursor is about 45-52 wt % for preparing SiC ceramics. This method was invented by S. Yajima, and found a wide range of applications.

Among them, in the aforementioned organic precursor method, to prepare polycarbosilane, it is required to first synthesize a polysilane, such as polydimethylsilane, polymethylphenylsilane and the like, and then under a condition of high temperature and high pressure, it is converted by methyl rearrangement into a polycarbosilane, which is soluble in non-polar organic solvents, the yield for resulting polycarbosilane is about 45 wt %. The main disadvantages are that reaction process is long, time consumption is lengthy, process conditions are harsh, and a large quantity of byproducts are formed.

Introduction of elements such as titanium, zirconium and aluminum into SiC ceramics can improve the heat resistance and oxidation resistance; however, so far the metal elements are generally introduced by reacting metal alkoxide or metal oxo-alkane or the like with polycarbosilane to prepare an oxygen-containing poly(titano/zircono) carbosilane and removing oxygen by means of carbothermic reaction or the like during high-temperature pyrolysis. Metal elements such as titanium and zirconium are generally present with a content of not more than 3%. High-performance ceramic fiber has combined spinnable and processable properties of fibers with excellent performances of ceramics, such as high strength, high modulus, high temperature resistance, anticorrosion, antioxidation, low density, and the like, and finds wide applications in composite reinforcements for preparing metal and ceramic-based composites. Currently non-oxide high temperature ceramic fibers are mainly SiC fibers, including SiC fiber obtained by organic polymer precursor conversion method, SiC fiber obtained by chemical vapor deposition method, SiC fiber obtained by carbon template conversion method, and the like, wherein organic silicon polymer compounds are used as raw materials for preparing SiC fibers by organic precursor method, and inorganic ceramic fibers with β-SiC structure are produced upon spinning, non-melting treatment and ceramization; this is currently a well-developed method and has realized industrialized production.

For the preparation of high temperature resistant and antioxidant SiC fibers, the main consideration is how to reduce contents of oxygen and free carbon in SiC fibers and prepare SiC fibers with nearly stoichiometric ratio and high compactness. In publicized patents, by introducing a small amount of foreign elements such as Al, B, Ti, Zr, etc. into fiber, a ceramic-microcrystalline eutectoid is formed during fiber cracking, thus grain is suppressed from growing excessively with a good effect. For example, Tyranno ZM containing 1.0% Zr and Tyranno Lox-E containing 1.9% Ti from Japan Ube Industries as well as Sylramic Fibers containing 2.1% Ti from Dow Corning Corporation can achieve a anti-oxidation temperature up to around 1500° C. Siborami Fibers (SiBN₃C) developed by Bayer company of Germany is stable in an inert atmosphere until 1800° C. and is oxidation resistant at 1500° C. However, except for Siboramic Fibers with a higher content of elements B and N introduced, other types of silicon carbide fiber introduce less Ti/Zr, mainly due to the way in which metal elements such as Zr/Ti/Al etc. are introduced. That is, for the aforementioned fibers, organic polymers containing Si—H bond are used as raw materials, such as polysilacarbosilane (PSCS), polysilane (PS), polycarbosilane (PCS) and the like, and oxygen-containing organometallic compounds of Zr/Ti/Al are added as reaction additives, such as acetylacetonates, carbonyl compounds, and keto compounds thereof, thus forming organic polymers containing Zr/Ti/Al. Due to limitations of oxygen-containing structures in the Zr/Ti/Al organometallic compounds and extents of reaction with Si—H bond in the organic silicon precursors, it is difficult to form a highly doped multiphase ceramic structure, and contents of Ti/Zr introduced are less, usually the mass fractions are less than 3%.

In MC.MB₂.SiC (M=Ti, Zr and Hf) ternary multiphase ceramics, all ceramic components have very high melting points, for example, ZrC has a melting point of 3540° C., ZrB₂ has a melting point of 3245° C., and they have excellent high temperature resistance and oxidation resistance. Multiphase ceramic materials with an anti-oxidation temperature over 2500° C. have been prepared successfully by powder hot-pressing technology. Especially due to hindrance of grain boundaries, for multiphase ceramics obtained by precursor pyrolysis, crystallization temperature is increased by about 500° C. compared with that for pyrolytic SiC, thus it is expected that preparation of multicomponent multiphase ceramic fibers containing SiC and MC and/or MB₂ can meet demands for preparing more high-temperature resistant composite materials.

### SUMMARY OF INVENTION

A first object of the present invention is to provide a novel polymetallocarbosilane, in which metal content is adjustable, and metallocene and carbosilane are present in a form of chemically bonded polymer.

The polymetallocarbosilane according to the present invention has the following structural formula:

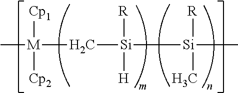

Wherein, R is methyl, ethyl, propyl, ethenyl, chloromethyl, phenyl or phenethyl; M is Ti, Zr or Hf; m is an integer equal to or greater than 1, n is an integer equal to or greater than 0, and Cp₁ and Cp₂ are each a cyclopentadienyl or substituted cyclopentadienyl group.

In a preferred example of the present invention, said polymetallocarbosilane has the following structural formula:

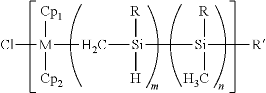

Wherein R is methyl, ethyl, propyl, ethenyl, chloromethyl, phenyl or phenethyl; R′ is Cl, CH₂-MCp₁Cp₂Cl, Si(Me)₃, CH₃, C₂H₅, OH, OCH₃ or OC₂H₅.

A second object of the present invention is to provide a method for preparing the aforementioned polymetallocarbosilane, the preparation conditions are mild and controllable.

The method for preparing polymetallocarbosilane according to the present invention comprises the steps of:

(1) Adding reactant 1 and reactant 2 in proportion to an organic solvent, and adding reactant 3 dropwise to the reaction system at a reaction temperature of 0-160° C., allowing to react sufficiently until the reaction system is neutral, and cooling to room temperature;
(2) Removing precipitate from the reaction system to obtain a solution G, and removing solvent from the solution G to obtain said polymetallocarbosilane;
Wherein, in step (1), the reactant 1 is a bis(cyclopentadienyl) M dichloride or bis(substituted cyclopentadienyl) M dichloride, M is Ti, Zr or Hf, and the reactant 2 is an alkali metal, the organic solvent is a non-polar solvent, and the reactant 3 has the following structural formula:

SiR¹R²Cl₂

Wherein, R¹ is methyl; R² is methyl, ethyl, propyl, ethenyl, chloromethyl, phenyl or phenethyl;
Wherein, the material amount ratio of the reactant 1 to the reactant 3 is 1:50 to 1:1, the ratio of material amount of the reactant 2 to material amount of Cl contained in the reactant 1 and the reactant 3 in total is 1-1.25 (for example, when the material amount of reactant 2 is 1 mole, the sum of material amount of element Cl contained in the reactant 1 and material amount of element Cl contained in the reactant 3 is 1-1.25 moles), and the mass of the organic solvent is 3-10 times that of the reactant 3;

Wherein, steps (1) and (2) are both carried out under an anhydrous oxygen-free condition with inert gas protection.

In a preferred example of the present invention, the ratio of material amount of the reactant 2 to material amount of Cl contained in the reactant 1 and the reactant 3 in total is 1-1.1.

In another preferred example of the present invention, said reaction temperature is 90-110° C.

In yet another preferred example of the present invention, said non-polar solvent is toluene or xylene.

In yet another preferred example of the present invention, said alkali metal is sodium, potassium or sodium-potassium alloy.

In yet another preferred example of the present invention, said inert gas is nitrogen or argon.

In yet another preferred example of the present invention, in the reaction step (2), the product obtained after removal of solvent from the solution G is subjected to reforming at a reforming temperature of 90-350° C., thereafter to obtain said polymetallocarbosilane.

A third object of the present invention is to provide a composite carbide and preparation method thereof, wherein various carbides are uniformly and dispersively distributed in the composite carbide.

The method for preparing composite carbide according to the present invention comprises the step of:

Using the polymetallocarbosilane mentioned in the first object of the present invention as a precursor and performing heat treatment at high temperature above 1100° C. with inert gas protection, thus obtaining a SiC. MC composite carbide. Preferred process conditions are that heating rate being 1-5° C./min, heat treatment temperature being 1100-1600° C., and maintaining at the temperature for 1-4 hours.

In prior art, mass fractions of metal elements such as titanium, zirconium and the like introduced into SiC fibers are lower, and oxygen content is high, it is difficult to achieve uniform dispersion, a multiphase ceramic structure can not be formed, and therefore it is unable to obtain more oxidation resistant ceramic fibers; in view of the above-mentioned disadvantages, a fourth object of the present invention is to provide a novel carbide and/or boride based multiphase ceramic fiber and preparation method thereof.

According to one aspect of the present invention, there is provided a multiphase ceramic fiber, the components of which including SiC and MC and/or MB₂, and SiC and MC and/or MB₂ being uniformly and dispersively distributed, wherein M is one or more of Ti, Zr and Hf That is, the multiphase ceramic fiber must contain SiC, and further contains at least one of MC and MB₂; MC may be a combination of one or more of TiC, ZrC and HfC, and MB₂ may be a combination of one or more of TiB₂, ZrB₂ and HfB₂.

In a specific example of the present invention, SiC constitutes an incomplete crystalline continuous phase, and MC and/or MB₂ is dispersed in the continuous phase of SiC with a particle size of 2-200 nm. Preferably, the particle size of MC and/or MB₂ is 2-50 nm.

In a preferred example of the present invention, M represents a mass fraction of 3%-30% in the entirety of the multiphase ceramic fiber. In another specific example of the present invention, a single organic polymer precursor or composite organic polymer precursors containing elements of M, Si, C, H and optionally B are used as raw material(s) for preparation.

According to another aspect of the present invention, there is provided a method for preparing the above-mentioned multiphase ceramic fiber, comprising the steps of:

(1) Adding a single organic polymer precursor or composite organic polymer precursors containing elements of M, Si, C, H and optionally B into a melt spinning tank, melting and defoaming at 90-180° C., after that pressurizing to 0.1-0.7 MPa for melt spinning, thereby obtaining a raw fiber;
(2) Subjecting the resulting raw fiber to aging stabilization, then rising to 1100-1600° C. at a heating rate of 0.5-3° C./min, and obtaining a multiphase ceramic fiber after heat treatment (ceramization).

In step (1), the polymer precursor may be a single precursor, i.e. polymetallocarbosilane mentioned in the first object of the present invention, or the polymer precursors may also be composite precursors formed by mixing polymetallocarbosilane mentioned in the first object of the present invention with polyborazine.

Preferably in step (1), treatment temperature for melting and defoaming of the organic polymer(s) is 155-165° C.; spinning pressure is 0.3-0.5 MPa. Preferably in the aging stabilization treatment of step (2), the fiber surface is cured by way of cross-linking in air or other oxidizing atmospheres or UV cross-linking. In order to enhance mechanical properties of the fiber, a certain drafting force may be applied during the heat treatment of step (2).

The beneficial effects of the present invention are as follows:

(1) A novel polymetallocarbosilane is provided, said polymetallocarbosilane contains no oxygen, metallocene and carbosilane are present in a chemically bonded form, and metal content is adjustable.
(2) In the method of the present invention, metallocene is used to catalyze addition polymerization of organosilane to produce polymetallocarbosilane, the raw materials used and synthetic procedure are free of oxygen, and it can be carried out at an atmospheric reflux temperature of toluene; a Si—CH₂—Si bond can be formed at an atmospheric pressure and a relatively low temperature (<110° C.), while forming a Si—H bond; reaction steps are simple, reaction conditions are mild, production costs are low, and conversions with respect to products are high.
(3) The polymetallocarbosilane provided by the present invention can be converted into a highly purified SiC.MC multiphase ceramic (M=Ti, Zr or Hf) by heat treatment in an inert atmosphere above 1100° C. Ceramization transition temperature thereof is relatively low, mass yield of the ceramic is 20-65%, and the resulting multiphase ceramic is a nano-dispersed multiphase SiC.MC ceramic.
(4) The polymetallocarbosilane provided by the present invention contains a reactive functional group Si—H, which can undergo a polymerization reaction with a precursor containing a functional group B—Cl, —NHCH₃ or C═C to introduce corresponding elements of B, N, C and the like for the preparation of a MC.MB₂.SiC multicomponent multiphase ceramic (M=Ti, Zr or Hf).
(5) In the multicomponent multiphase ceramic fiber provided by the present invention and formed by combination of MC and/or MB₂ with SiC, the mass content of M is greater than 3%, and MC and/or MB₂ is uniformly dispersed in the continuous phase of SiC, which greatly extends the range of choice for the components and proportions of the multiphase ceramic fiber.
(6) In the multicomponent multiphase ceramic fiber provided by the present invention and formed by combination of MC and/or MB₂ with SiC, the multicomponent ceramic is dispersively distributed in nanoscale, this can effectively suppress the grain growth of various components, especially SiC, which is in favour of improving the resistance of the fiber to high temperature creep.
(7) In the preparation method of the multicomponent multiphase ceramic fiber provided by the present invention and formed by combination of MC and/or MB₂ with SiC, the melt spinning temperature and non-melting temperature of the precursor(s) are even lower, this broadens the types of precursor and the uses of matrix, making the method more economically applicable.

### BRIEF DESCRIPTION OF DRAWINGS

FIG. 1 is an IR pattern of polyzirconocarbosilane prepared in Example 1.

FIG. 2 is a TGA pattern of the polyzirconocarbosilane prepared in Example 1.

FIG. 3 is an IR pattern of polyzirconocarbosilane prepared in Example 2.

FIG. 4 is an XRD pattern of a ceramic product obtained after heat treatment of the polyzirconocarbosilane prepared in Example 1.

FIG. 5 is a SEM photograph of the ceramic product obtained after heat treatment of the polyzirconocarbosilane prepared in Example 1.

FIG. 6 is a SEM photograph of a raw fiber prepared in Example 13.

FIG. 7 is a backscattered SEM photograph of a cross-section of a multiphase ceramic fiber prepared in Example 13.

FIG. 8 is a TEM photograph of the multiphase ceramic fiber prepared in Example 13.

FIG. 9 is a SEM photograph of a raw fiber prepared in Example 14.

FIG. 10 is an XRD pattern of a multiphase ceramic fiber prepared in Example 14, and

FIG. 11 is a TEM photograph of the multiphase ceramic fiber prepared in Example 14.

### SPECIFIC IMPLEMENTATIONS

By the following specific examples, the present invention will be further described in conjunction with the accompanying drawings. Those skilled in the art will understand that the following description is only for explaining the present invention rather than posing any restrictions. First, the polymetallocarbosilane of the present invention and its preparation method will be described by way of specific examples.

### Example 1

At room temperature and with nitrogen protection, 12 g Na sheet and 250 mL toluene were added into a 500 mL four-neck flask, and it was stirred at high speed for 5 minutes at 110° C. to process the sodium sheet into sodium sands, afterwards the stirring was stopped, and it was cooled to 100° C.; 20.46 g (0.07 mol) zirconocene dichloride was added, and 27.10 g (0.21 mol) dichlorodimethylsilane was added dropwise slowly, and then it was stirred for 5 hours with nitrogen protection and 100° C. heating, until the solution was neutral, then the heating was stopped, and it was naturally cooled to room temperature to obtain a solution G1. Under a condition of −0.1 MPa and 60° C., a rotary evaporator was used to remove toluene solvent from the solution G1, thus 24.35 g black brown viscous polymer was obtained, namely polyzirconocarbosilane A1, with a yield of 88.03 wt % (calculated on the basis of theoretical yield of the resulting polymetallocarbosilane).

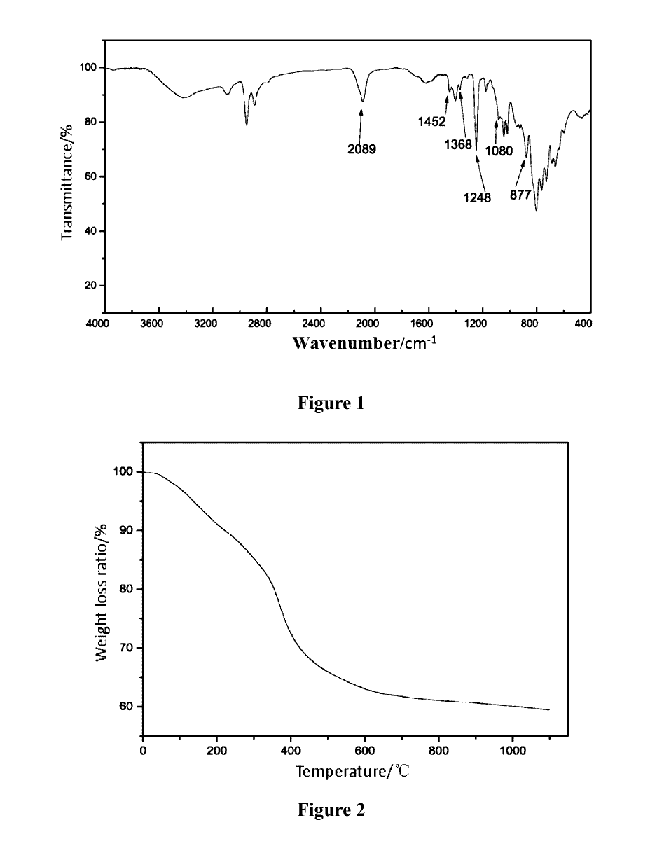

Infrared spectroscopic analysis was carried out for the solid product A1 by KBr tabletting method, and results were shown in FIG. 1, in which the absorption peaks at wavenumbers 1452 cm⁻¹ and 1080 cm⁻¹ corresponded to absorption peaks of cyclopentadienyl in zirconocene; the absorption peaks at wavenumbers 2089 cm⁻¹ and 877 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; and the absorption peaks at wavenumbers 1398 cm⁻¹ and 1248 cm⁻¹ corresponded to absorption peaks of Si—CH₃ bond. The above analysis showed that Si—CH₃ in dichlorodimethylsilane underwent addition polymerization under the synergistic action of alkali metal Na and zirconocene dichloride, and a polyzirconocarbosilane containing Si—CH₂—Si, Si—H and Si—CH₃ was formed.

Elemental analysis was carried out for the solid product A1, and results were as follows: Si (19.50 wt %), C (44.58 wt %), Zr (21.20 wt %), H (6.50 wt %), Cl (10.74 wt %), and O (0.01 wt %), where Cl is an end group, and the chlorine end group can be replaced by introducing another capping agent, such as ClSi(CH₃)₃, LiCH₃, HOCH₃ or the like; the small quantity of oxygen may be due to oxidation of the polymer during measurement. Therefore, said product has a chemical formula of Si₃C₁₆ZrH₂₈Cl_{1.34}. Molecular weight and molecular weight distribution of the polymer A1 were measured by gel permeation chromatography (GPC), and results were Mₙ=1200 and Mw/Mₙ=1.2, respectively, the molecular weight distribution was relatively uniform.

FIG. 2 is a TGA curve of said product A1 which was raised to 1100° C. at a heating rate of 10° C./min under Ar. As can be seen from FIG. 2, for said product, weight loss occurred slowly at 200° C., weight loss in the range of 250-600° C. was about 40%, weight loss above 600° C. slowed, and ceramic yield with respect to said product was about 62% at 1100° C.

### Example 2

At room temperature and with nitrogen protection, 12.88 g metal K and 150 mL xylene were added into a 500 mL four-neck flask, then 4.38 g (0.015 mol) zirconocene dichloride was added at 60° C. with stirring, and 28.67 g (0.15 mol) dichloromethylphenylsilane was added dropwise slowly, and then it was stirred for 5 hours while heating at 60° C., until the clear solution was neutral, then the heating was stopped, and it was naturally cooled to room temperature to obtain a solution G2. Removing solvent from the solution G2 gave 20.24 g viscous polymer, namely polyzirconocarbosilane A2, with a yield of 87.13%.

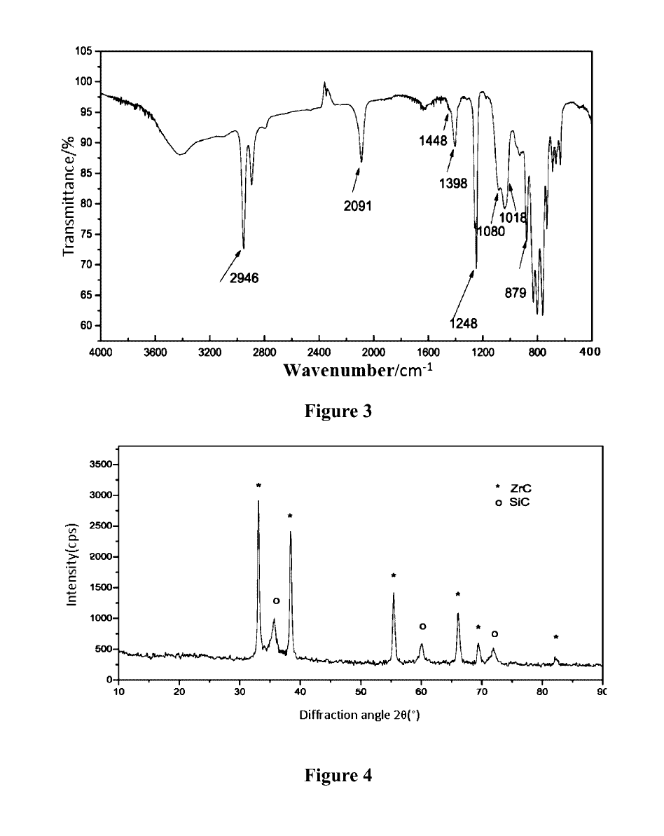

Infrared spectroscopic analysis was carried out for the viscous polymer A2 by KBr tabletting method, and results were shown in FIG. 3, in which the absorption peaks at wavenumbers 1448 cm⁻¹ and 1080 cm⁻¹ corresponded to absorption peaks of cyclopentadienyl in zirconocene; the absorption peaks at wavenumbers 2091 cm⁻¹ and 879 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; the absorption peaks at wavenumbers 1398 cm⁻¹ and 1248 cm⁻¹ corresponded to absorption peaks of Si—CH₃ bond; the very weak absorption peaks at wavenumbers 1488 cm⁻¹, 1815 cm⁻¹, 1879 cm⁻¹ and 1950 cm⁻¹ corresponded to absorption peaks of phenyl group; and the absorption peak at wavenumber 2946 cm⁻¹ corresponds to strong absorption peak of phenyl group. The above analysis showed that Si—CH₃ in dichloromethylphenylsilane underwent addition polymerization under the synergistic action of alkali metal K and zirconocene dichloride, and a polyzirconocarbosilane containing Si—CH₂—Si, Si—H, Si—CH₃ and Si-Ph was formed.

Elemental analysis was carried out for the solid product A2, and results were as follows: Si (19.65 wt %), C (67.45 wt %), Zr (6.40 wt %), H (6.23 wt %), and Cl (0.27 wt %). Therefore, said product has a chemical formula of Si_{9.8}C₈₀ZrH₉₀Cl_{1.50}.

Molecular weight and molecular weight distribution of the polymer A2 were measured by gel permeation chromatography (GPC), and results were Mₙ=1000 and Mw/Mₙ=1.5, showing that the molecular weight distribution of the product was relatively uniform.

### Example 3

At room temperature and with nitrogen protection, 11.5 g Na and 280 mL xylene were added into a 500 mL four-neck flask, then 2.49 g (0.01 mol) titanocene dichloride was added at 110° C. with stirring, and 25.81 g (0.2 mol) dichlorodimethylsilane was added dropwise slowly, and then it was stirred for 8 hours while heating at 140° C., until the solution was neutral, then the heating was stopped, and it was naturally cooled to room temperature to obtain a solution G3. Removing solvent from the solution G3 gave 10.2 g viscous polymer, namely polytitanocarbosilane A3, with a yield of 76.23%.

Infrared spectroscopic analysis was carried out for the solid product A3 by KBr tabletting method, and results showed that the absorption peaks at wavenumbers 1452 cm⁻¹ and 1080 cm⁻¹ corresponded to absorption peaks of cyclopentadienyl in titanocene; the absorption peaks at wavenumbers 2089 cm⁻¹ and 877 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; and the absorption peaks at wavenumbers 1398 cm⁻¹ and 1248 cm⁻¹ corresponded to absorption peaks of Si—CH₃ bond. The above analysis showed that Si—CH₃ in dichlorodimethylsilane underwent addition polymerization under the synergistic action of metal Na and titanocene dichloride, and a polytitanocarbosilane containing Si—CH₂—Si, Si—H and Si—CH₃ was formed. Elemental analysis was carried out for the solid product A3, and results were as follows: Si (34.76 wt %), C (46.34 wt %), Ti (6.62 wt %), H (8.83 wt %), O (0.02 wt %), and Cl (3.43 wt %), the small quantity of oxygen may be due to oxidation of the polymer during measurement. Therefore, said product has a chemical formula of Si_{19.9}C₂₈TiH₆₄Cl.

Molecular weight and molecular weight distribution of the polymer A3 were measured by gel permeation chromatography (GPC), and results were Mₙ=800 and Mw/Mₙ=1.4, showing that the molecular weight distribution of the product was relatively uniform.

### Example 4

At room temperature and with nitrogen protection, 3.0 g lithium metal sheet, 300 mL trimethylbenzene and 3.80 g (0.01 mol) hafnocene dichloride were added into a 500 mL four-neck flask, then it was raised to 160° C. with stirring, 12.90 g (0.1 mol) dichlorodimethylsilane and 19.11 g (0.1 mol) dichloromethylphenylsilane were added dropwise slowly, and then it was stirred for 5 hours with nitrogen protection and 160° C. heating, until the solution was neutral, then the heating was stopped, and it was naturally cooled to room temperature to obtain a solution G4. Removing solvent from the solution G4 gave 18.76 g viscous polymer, namely polyhafnocarbosilane A4, with a yield of 93.75%.

Infrared spectroscopic analysis was carried out for the solid product A4 by KBr tabletting method, and results showed that the absorption peaks at wavenumbers 1452 cm⁻¹ and 1080 cm⁻¹ corresponded to absorption peaks of cyclopentadienyl in hafnocene dichloride; the absorption peaks at wavenumbers 2089 cm⁻¹ and 877 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; the absorption peaks at wavenumbers 1398 cm⁻¹ and 1248 cm⁻¹ corresponded to absorption peaks of Si—CH₃ bond; and the absorption peaks at wavenumbers 1488 cm⁻¹, 1815 cm⁻¹, 1879 cm⁻¹ and 1950 cm⁻¹ corresponded to absorption peaks of phenyl group. The above analysis showed that Si—CH₃ in dichlorodimethylsilane and dichloromethylphenylsilane underwent addition polymerization under the synergistic action of metal Li and hafnocene dichloride, and a polyhafnocarbosilane containing Si—CH₂—Si, Si—H, Si—CH₃ and Si-Ph was formed.

Elemental analysis was carried out for the solid product A4, and results were as follows: Si (26.81 wt %), C (55.45 wt %), Hf (8.5 wt %), H (7.18 wt %), O (0.02 wt %), and Cl (3.28 wt %), the small quantity of oxygen may be due to oxidation of the polymer during measurement. Therefore, said product has a chemical formula of Si₂₀C₅₄HfH₉₀Cl_{1.23}.

Molecular weight and molecular weight distribution of the polymer A4 were measured by gel permeation chromatography (GPC), and results were Mₙ=600 and Mw/Mₙ=1.5, the molecular weight distribution of the product was relatively uniform.

### Example 5

At room temperature and with nitrogen protection, 10.0 g Na and 300 mL toluene were added into a 500 mL four-neck flask, and it was stirred at high speed for 10 minutes at 110° C., afterwards the stirring was stopped, and it was cooled to 95° C.; 1.39 g (0.004 mol) bis(ethylcyclopentadienyl) zirconium dichloride (η⁵-C₂H₅C₅H₄)₂ZrCl₂) was added, and 25.81 g (0.2 mol) dichlorodimethylsilane was added dropwise slowly, and then it was stirred for 15 hours with nitrogen protection and 100° C. heating, afterwards the heating was stopped, and it was naturally cooled to room temperature to obtain a solution G5. Removing solvent from the solution G5 gave 8.05 g viscous polymer, namely polyzirconocarbosilane A5, with a yield of 56.02%.

Infrared spectroscopic analysis was carried out for the solid product A5 by KBr tabletting method, and results showed that the absorption peaks at wavenumbers 1452 cm⁻¹ and 1080 cm⁻¹ corresponded to absorption peaks of cyclopentadienyl in bis(ethylcyclopentadienyl) zirconium dichloride; the absorption peaks at wavenumbers 2089 cm⁻¹ and 877 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; and the absorption peaks at wavenumbers 1398 cm⁻¹ and 1248 cm⁻¹ corresponded to absorption peaks of Si—CH₃ bond. The above analysis showed that Si—CH₃ in dichlorodimethylsilane underwent addition polymerization under the synergistic action of metal Na and bis(ethylcyclopentadienyl) zirconium dichloride, and a polyzirconocarbosilane containing Si—CH₂—Si, Si—H and Si—CH₃ was formed.

Elemental analysis was carried out for the solid product A5, and results were as follows: Si (43.10 wt %), C (42.11 wt %), Zr (2.80 wt %), H (9.79 wt %), Cl (2.15 wt %), and O (0.03 wt %), the small quantity of oxygen may be due to oxidation of the polymer during measurement. Therefore, said product has a chemical formula of Si₅₀C₁₁₄ZrH₃₁₈Cl_{1.9}.

Molecular weight and molecular weight distribution of the polymer A5 were measured by gel permeation chromatography (GPC), and results were Mₙ=790 and Mw/Mₙ=1.3, respectively, showing that the molecular weight distribution of the product was relatively uniform.

### Example 6

At 0° C. and with nitrogen protection, 10.0 g Na—K alloy and 300 mL toluene were added into a 500 mL four-neck flask, then 2.92 g (0.01 mol) zirconocene dichloride was added, then 25.81 g (0.2 mol) dichlorodimethylsilane was added dropwise slowly, and it was stirred for 42 hours, until the solution was neutral, then the cooling and stirring were stopped, and it was naturally raised to room temperature to obtain a solution G6. Removing solvent from the solution G6 gave 9.00 g viscous polymer, namely polyzirconocarbosilane A6, with a yield of 61.0%. Infrared spectroscopic analysis was carried out for the solid product A6 by KBr tabletting method, and results showed that the absorption peaks at wavenumbers 1452 cm⁻¹ and 1080 cm⁻¹ corresponded to absorption peaks of cyclopentadienyl in bis(ethylcyclopentadienyl) zirconium dichloride; the absorption peaks at wavenumbers 2089 cm⁻¹ and 877 cm⁻¹ corresponded to absorption peaks of Si—H bond; the absorption peaks at wavenumbers 1368 cm⁻¹ and 1018 cm⁻¹ corresponded to absorption peaks of Si—CH₂—Si bond; and the absorption peaks at wavenumbers 1398 cm⁻¹ and 1248 cm⁻¹ corresponded to absorption peaks of Si—CH₃ bond. The above analysis showed that Si—CH₃ in dichlorodimethylsilane could undergo addition polymerization at a low temperature under the synergistic action of Na—K alloy and zirconocene dichloride to form a polyzirconocarbosilane containing Si—CH₂—Si, Si—H and Si—CH₃. Elemental analysis was carried out for the solid product A6, and results were as follows: Si (50.28 wt %), C (30.30 wt %), Zr (8.23 wt %), H (6.67 wt %), Cl (4.48 wt %), and O (0.04 wt %), the small quantity of oxygen may be due to oxidation of the polymer during measurement. Therefore, said product has a chemical formula of Si_{19.9}C₂₈ZrH₇₄Cl_{1.4}.

Molecular weight and molecular weight distribution of the polymer A6 were measured by gel permeation chromatography (GPC), and results were Mₙ=680 and Mw/Mₙ=1.3, respectively, showing that the molecular weight distribution of the product was relatively uniform.

### Example 7

At room temperature and with nitrogen protection, 7.60 g Na and 150 mL xylene were added into a 500 mL four-neck flask, and it was stirred at high speed for 10 minutes at 110° C., afterwards the stirring was stopped, and it was cooled to 95° C.; 2.92 g (0.015 mol) zirconocene dichloride was added, and 25.3 g (0.15 mol) dichlorodiphenylsilane was added dropwise slowly, and it was stirred for 4 hours while heating at 100° C., then the heating was stopped, and it was naturally cooled to room temperature to obtain a solution G7. Removing solvent from the solution G7 gave 9.1 g pale yellow solid polymer A7, while a crystalline product C7 could be observed on the container wall.

Analysis was carried out for the crystalline product C7 by KBr tabletting method, and its infrared absorption peaks were consistent with those of the standard zirconocene dichloride, showing that there was zirconocene dichloride raw material mixed in the product, that did not participate in the reaction.

Chloroform was used to wash the pale yellow solid product A7, such that zirconocene dichloride therein was removed, and a white polymer A7* was obtained. Infrared spectroscopic analysis was carried out for the white solid product A7* by KBr tabletting method, and results showed that the absorption peaks at wavenumbers 1488 cm⁻¹, 1815 cm⁻¹, 1879 cm⁻¹ and 1950 cm⁻¹ corresponded to absorption peaks of phenyl group; no absorption peaks of Si—H were observed among the infrared absorption peaks. Elemental analysis was carried out for A7* and results were as follows: Si (15.40 wt %), C (79.11 wt %), H (5.45 wt %), and O (0.03 wt %). Therefore, said product has a chemical formula of SiC₁₂H₁₀O_{0.01}, structurally close to polydiphenylsilane.

The results showed that zirconocene dichloride had no catalytic rearrangement function for dichlorodiphenyl monomer, and did not participate in the formation of polymer.

5 g sample was taken respectively from the polymers obtained in Example 1 to Example 6, and its toluene solubility and xylene solubility were measured at room temperature. When 100 g solvent can dissolve more than 50 g polymer, the solubility is designated as Excellent, and when 100 g solvent dissolves less than 50 g polymer, the solubility is designated as Good. Results were shown in Table 1.

TABLE 1
Solubility of polymer in solvent

| Samples | Solubility in toluene | Solubility in xylene |
|---|---|---|
| Example 1 | Excellent | Excellent |
| Example 2 | Excellent | Excellent |
| Example 3 | Excellent | Excellent |
| Example 4 | Excellent | Excellent |
| Example 5 | Excellent | Excellent |
| Example 6 | Excellent | Excellent |

As can be seen from Example 1 to Example 7, by using one or more dichloroalkylsilane monomer(s) containing Si—CH₃ as raw material(s) and bis(cyclopentadienyl) metal (titanium, zirconium or hafnium) dichloride or bis(substituted cyclopentadienyl) metal (zirconium, titanium or hafnium) dichloride as a catalyst, and by way of synergistic action of alkali metal Li, Na or K, methyl rearrangement and addition polymerization of metallocene are realized, and a polymetallocarbosilane is obtained, which has excellent solubilities in non-polar solvents such as toluene and xylene; by adjusting content of the metallocene reactant, polymetallocarbosilanes with different metal contents may be formed. If the raw material is a dichloroalkylsilane monomer containing no Si—CH₃, such as dichlorodiphenylsilane, a similar addition polymerization will not occur.

In the preparation method of the present invention, the target product is polycarbosilane containing elements such as titanium, zirconium, and hafnium, the S. Yajima process is avoided, in which polymethylsilane is first prepared, and then a polycarbosilane is prepared via complex reaction of methyl rearrangement. In the present invention, tedious steps, such as the separation of polydimethylsilane with metallic sodium and sodium chloride, purification, drying, and the like, are not required, thus reaction process is shortened; as thermal rearrangement at high temperature (>450° C.) and high pressure (>8 MPa) is unnecessary, preparation conditions are milder, reaction conditions are more unrestricted, and product conversion is greatly increased (greater than 85%).

Under an Ar atmosphere, the polymetallocarbosilanes obtained in Example 1 to Example 6 were raised to 1100° C. at a heating rate of 10° C./min, maintained at the temperature for 1 hour, and then cooled to room temperature; after the above heat treatment, ceramic yield with respect to the resulting polymetallocarbosilane(i.e., weight ratio of the composite ceramic finally obtained to the polymetallocarbosilane that was used) was measured, and results were shown in Table 2.

TABLE 2
Ceramic yield comparison with respect to different polymers

| | Number | | |
|---|---|---|---|
| | average | | |
| | molecular | Si/M molar | Ceramic |
| Sample # | weight | ratio | yield |
| A1 | 1200 | 3:1 | 62% |
| A2 | 1000 | 10:1 | 36% |
| A3 | 800 | 20:1 | 26% |
| A4 | 600 | 20:1 | 31% |
| A5 | 790 | 50:1 | 24% |
| A6 | 680 | 20:1 | 32% |

As can be seen from Table 2, when molar ratio of the reactant containing Si to the reactant containing metallocene was relatively large, ceramic yield with respect to the resulting polymer decreased to about 25%. In order to increase the ceramic yield with respect to such polymers, the present inventors first carried out reforming treatments to the polymer obtained in Example 2 under different conditions, and then carried out high temperature heat treatment (under an Ar atmosphere, raised to 1100° C. at a heating rate of 10° C./min, maintained at the temperature for 1 hour, then cooled to room temperature); the resulting ceramic yield was measured, and results were shown in Table 3.

TABLE 3
Performance comparison of polymers obtained under different
treatment conditions

| | | | | Molecular | |
|---|---|---|---|---|---|
| Sample | | Temperature/ | Molecular | weight | Ceramic |
| # | Pressure | ° C. | weight | distribution | yield |
| A2-1 | atmospheric | 240 | 860 | 1.3 | 50% |
| | pressure | | | | |
| A2-2 | −0.098 MPa | 200 | 750 | 1.3 | 55% |
| A2-3 | 3 MPa | 240 | 880 | 1.3 | 60% |

As can be seen from Table 3, after removal of solvent from the solution G2, the resulting product was reformed under a certain temperature and pressure condition; after that, ceramic yield with respect to the resulting polymetallocarbosilane A2 (up to 60%) was greatly increased unexpectedly compared with ceramic yield with respect to non-reformed A2 (36%). This might be due to that reforming treatment could removing part of small molecules, reducing content of Si—Si bond in the polymer.

The possible mechanism of synthetic reaction for the polymetallocarbosilane precursor according to the present invention will be illustrated hereinbelow, taking the reaction of zirconocene dichloride with dichlorodimethylsilane under the action of sodium as an example:

### 1) Free Radical Initiation

Under the action of sodium, zirconocene dichloride and dichlorodimethylsilane are partially or completely dechlorinated, forming free radicals. Taking removal of only one Cl from zirconocene dichloride as an example, the illustrated reaction mechanism is as follows:

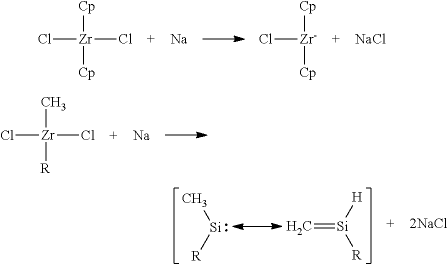

### 2) Formation of Carbon-Zirconium Chemical Bond

Monochlorozirconocene radical reacts with dimethylsilyl radical, forming Zr—C bond:

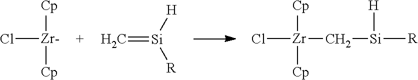

### 3) Catalytic Addition and Chain Growth

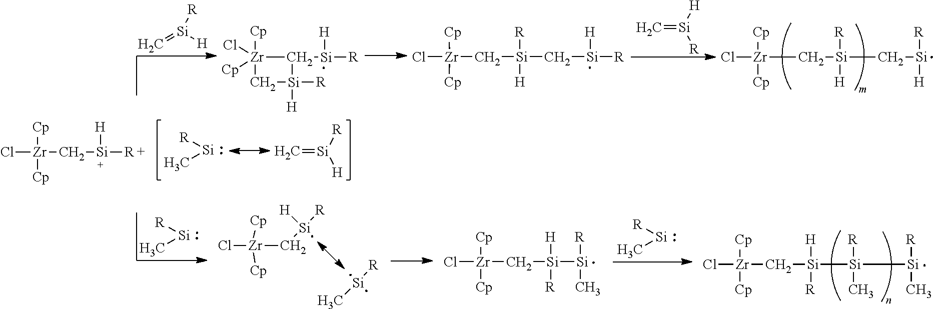

### 4) Chain Capping

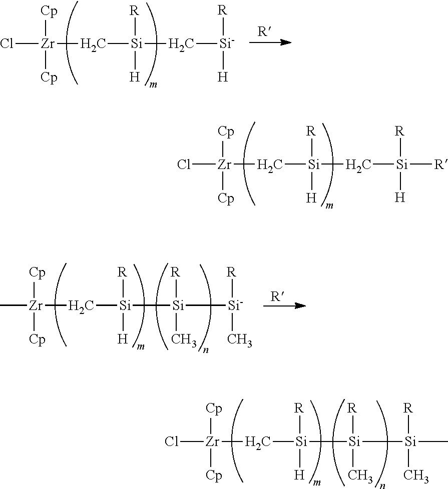

The following specific examples describe the preparation of composite carbide by using the polymetallocarbosilane according to the present invention as a raw material.

### Example 8

2 g polymer obtained in Example 1 was heated under an Ar atmosphere, raised to 1600° C. at a heating rate of 2° C./min, maintained at the temperature for 1 h, and then cooled at a cooling rate of 10° C./min, about 1.3 g gray-black solid was obtained. XRD (X-ray diffraction) measurement results were shown in FIG. 4, in which diffraction peaks appeared at 2θ angles of 33.074°, 38.386°, 55.377°, 66.049°, 69.337° and 82.208°, consistent with characteristic peaks of face-centered cubic ZrC; and of 35.744°, 60.026° and 72.033°, consistent with characteristic peaks of face-centered cubic SiC, confirming that the resulting solid is a SiC.ZrC composite.

As difference in atomic number between Si and Zr is large, there will be obvious disparity when performing backscattered electron imaging. The portion with a larger atomic number shows a brighter image, while the portion with a smaller atomic number shows a darker image. Distributed states of the two elements can be clearly differentiated by contrasting light and dark areas. Therefore, backscattered electron imaging technique was used to analyze the resulting ceramic product, and test results were shown in FIG. 5. As can be seen from FIG. 5, bright spots containing white color (Zr) were uniformly dispersed in nanoscale in gray matrix (Si). By analyzing in conjunction with FIG. 4, the resulting SiC.ZrC is a nanoscale uniformly distributed multiphase ceramic.

### Example 9

2 g polymer obtained in Example 2 was heated under an Ar atmosphere, raised to 1000° C. at a heating rate of 2° C./min, maintained at the temperature for 2 h, and then cooled at a cooling rate of 10° C./min, about 0.72 g gray-black solid was obtained. By XRD measurement, no apparent diffraction peaks were observed. 0.50 g of this gray-black solid was subjected to heat treatment by maintaining at 1100° C. under an Ar atmosphere for 1 h, after that it was cooled at a cooling rate of 10° C./min, and 0.5 g gray-black solid was obtained. Again by XRD measurement, results showed that: relatively weak diffraction peaks appeared at 2θ angles of 33.074°, 38.386°, 55.377°, 66.049° and 69.337°, consistent with characteristic peaks of face-centered cubic ZrC; and relatively weak diffraction peaks appeared at 2θ angles of 35.744°, 60.026° and 72.033°, consistent with characteristic peaks of face-centered cubic SiC, confirming that the resulting solid is a SiC.ZrC composite.

### Example 10

2 g polymer obtained in Example 3 was heated under an Ar atmosphere, raised to 1200° C. at a heating rate of 2° C./min, maintained at the temperature for 1 h, and then cooled at a cooling rate of 10° C./min, about 0.49 g gray-black solid was obtained. By XRD measurement, results showed that: relatively weak diffraction peaks appeared at 2θ angles of 36.040°, 41.987°, 60.899° and 72.673°, consistent with characteristic peaks of face-centered cubic TiC; and relatively weak diffraction peaks appeared at 2θ angles of 35.744°, 60.026° and 72.033°, consistent with characteristic peaks of face-centered cubic SiC, confirming that the resulting solid is a SiC.TiC composite.

### Example 11

2 g polymer obtained in Example 4 was heated under an Ar atmosphere, raised to 1400° C. at a heating rate of 2° C./min, maintained at the temperature for 4 h, and then cooled at a cooling rate of 10° C./min, about 0.58 g gray-black solid was obtained. By XRD measurement, results showed that: relatively weak diffraction peaks appeared at 2θ angles of 33.402°, 38.786°, 56.025°, 66.750°, 70.168° and 83.212°, consistent with characteristic peaks of face-centered cubic HfC; and relatively weak diffraction peaks appeared at 2θ angles of 35.744°, 60.026° and 72.033°, consistent with characteristic peaks of face-centered cubic SiC, confirming that the resulting solid is a SiC.HfC composite.

### Example 12

2 g polymer obtained in Example 5 was heated under an Ar atmosphere, raised to 1500° C. at a heating rate of 2° C./min, maintained at the temperature for 1 h, and then cooled at a cooling rate of 10° C./min, about 0.43 g gray-black solid was obtained. By XRD measurement, results showed that: diffraction peaks appeared at 2θ angles of 33.076°, 38.380°, 55.367°, 66.039°, 69.307° and 82.198°, consistent with characteristic peaks of face-centered cubic ZrC; and diffraction peaks appeared at 2θ angles of 35.744°, 60.026° and 72.033°, consistent with characteristic peaks of face-centered cubic SiC, confirming that the resulting solid is a SiC.ZrC composite.

As can be seen from Example 8 to 12, after heat treatment, the resulting polymer could be converted into a nanoscale uniformly distributed SiC.MC composite at a lower temperature (1100° C.). When heat treatment temperature reached 1600° C., diffraction peaks of SiC and MC could be clearly observed from the XRD pattern, i.e., the ceramic product was well crystallized.

The following specific examples describe the preparation of multiphase ceramic fiber by using the polymetallocarbosilane according to the present invention as a raw material.

### Example 13

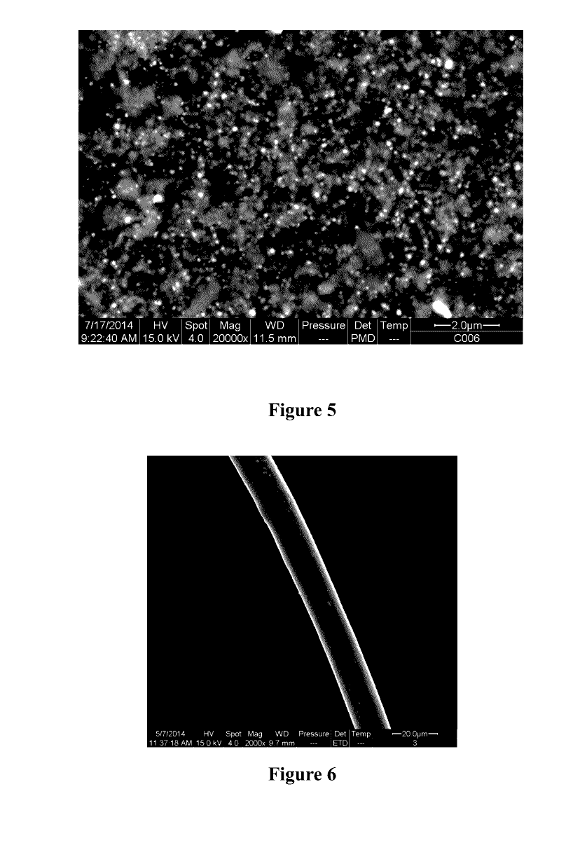

A polyzirconocarbosilane (containing Zr, Si, C and H) with a softening point of 70° C., a molecular weight of 1,500 and a molecular weight distribution of 1.2 was added into a melt spinning tank, melted at 160° C., maintained at constant temperature for 4 h, defoamed, and then cooled to 120° C., after that pressurized to 0.5 MPa with nitrogen gas, spun on a spinning machine, and a raw fiber was obtained at a filament collecting speed of 2 m/s. Microscopic morphology of the prepared raw fiber was shown in FIG. 6, and as shown, the resulting raw fiber had a smooth surface, its diameter was about 20 microns. 2 g raw fiber derived from Example 1 was subjected to aging at 200° C. under oxygen gas for 20 min, then raised to 1100° C. at a heating rate of 0.5° C./min under an Ar atmosphere, and maintained at the temperature for 1 h, after that cooled to obtain 1.25 g gray-black solid fiber.

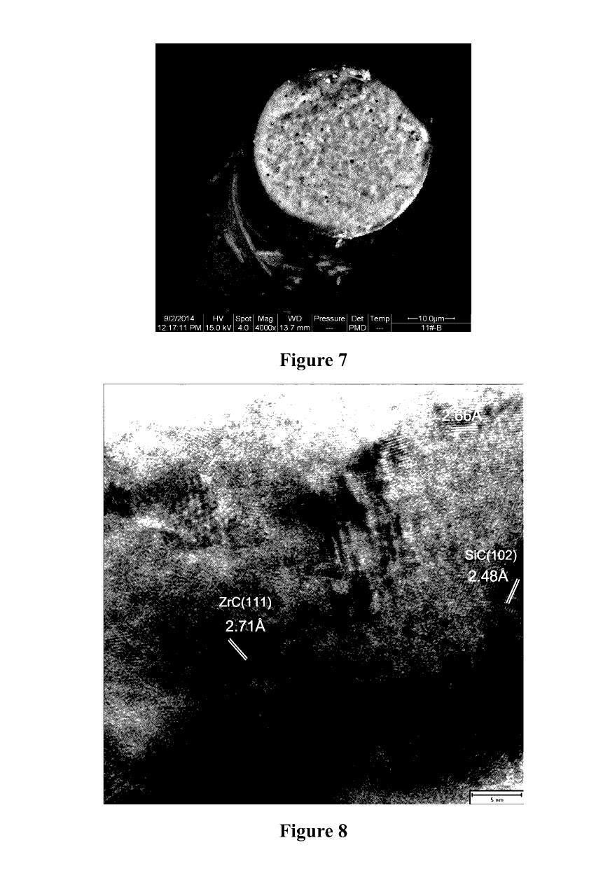

An inductively coupled plasma atomic emission spectrometer was used to measure the Zr element content in the resulting fiber, and test result was 16.2%. Phase composition of the resulting fiber was determined by XRD (X-ray diffraction method), and result showed that the resulting fiber contained crystalline phases of ZrC and SiC. Cross-section of the resulting fiber was observed by means of a backscattered scanning electron microscope (SEM), and result was shown in FIG. 7. The resulting fiber had a gray-black cross-section and had no apparent bright spots, showing that Zr element was uniformly and dispersively distributed in the fiber. A transmission electron microscopy (TEM) photograph of the resulting fiber cross-section was shown in FIG. 8, in which interplanar spacing 2.48 Å corresponded to the (102) plane of SiC, interplanar spacing 2.71 Å corresponded to the (111) plane of ZrC, and interplanar spacing 2.66 Å corresponded to the (101) plane of SiC. ZrC had a grain size of 10-50 nm, and was dispersed in nanoscale among SiC grains, thus forming a ZrC.SiC multiphase ceramic fiber.

### Example 14

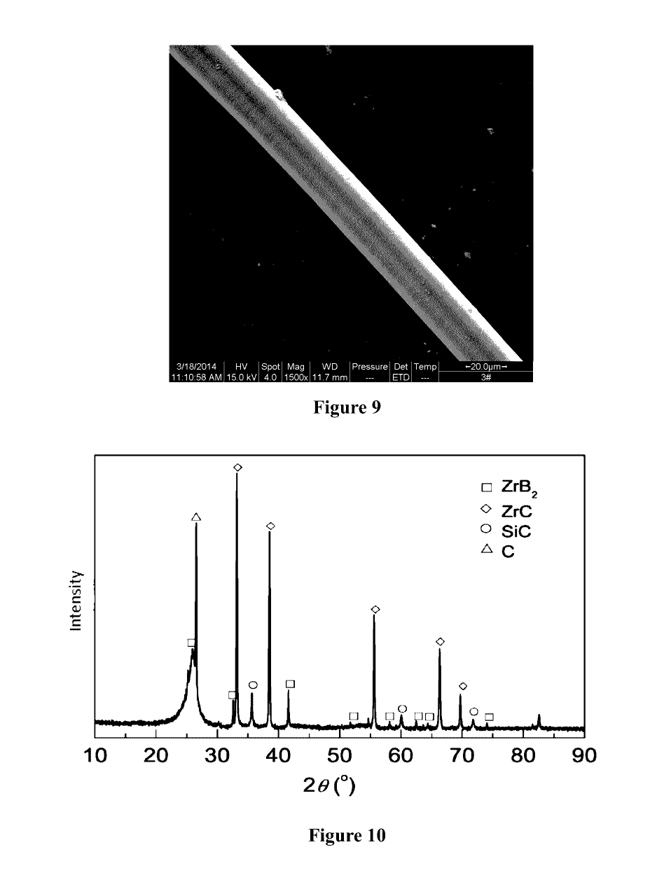

Composite precursors of polyzirconocarbosilane-polyborazine (containing Zr, Si, C, B and H) with a softening point of 75° C., a molecular weight of 2400 and a molecular weight distribution of 1.3 were added into a melt spinning tank, melted at 180° C., maintained at constant temperature for 6 h, defoamed, and then cooled to 110° C., after that pressurized to 0.7 MPa with nitrogen gas, spun on a spinning machine, and a raw fiber was obtained at a filament collecting speed of 2.5 m/s. Microscopic morphology of the prepared raw fiber was shown in FIG. 9, and as shown, the resulting raw fiber had a smooth surface, its diameter was about 25 microns. 2 g thus obtained raw fiber was subjected to aging at 150° C. under oxygen gas for 40 min, then raised to 1400° C. at a heating rate of 1.5° C./min under an Ar atmosphere, and maintained at the temperature for 1 h, after that cooled to obtain 1.30 g gray-black solid fiber.

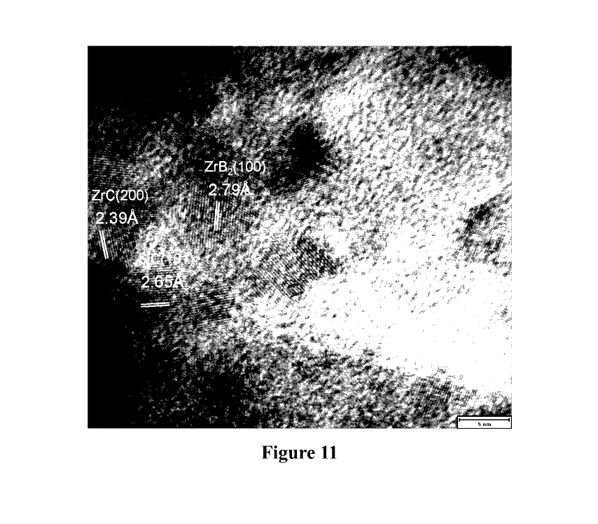

An inductively coupled plasma atomic emission spectrometer was used to measure the Zr element content in the fiber, and test result was 8.5%. Phase composition of the resulting fiber was determined by XRD, and result was shown in FIG. 10, showing that the resulting fiber contained crystalline phases of ZrC, ZrB₂, SiC and C. A transmission electron microscopy photograph of the resulting ceramic fiber was shown in FIG. 11, in which interplanar spacing 2.65 Å corresponded to the (101) plane of SiC, interplanar spacing 2.39 Å corresponded to the (200) plane of ZrC, and interplanar spacing 2.79 Å corresponded to the (100) plane of ZrB₂. ZrC and ZrB₂ had grain sizes in the range of 20-60 nm, and were dispersed in nanoscale among SiC grains, thus forming a ZrC.ZrB₂.SiC multiphase ceramic fiber.

### Example 15

A polytitanocarbosilane (containing Ti, Si, C and H) with a softening point of 80° C., a molecular weight of 1850 and a molecular weight distribution of 1.2 was added into a melt spinning tank, melted at 140° C., maintained at constant temperature for 8 h, defoamed, and then cooled to 100° C., after that pressurized to 0.3 MPa with nitrogen gas, spun on a spinning machine, and a raw fiber was obtained at a filament collecting speed of 2.8 m/s, the resulting raw fiber had a diameter of about 18 microns. 2 g thus obtained raw fiber was subjected to aging at 110° C. under oxygen gas for 60 min, then raised to 1500° C. at a heating rate of 3° C./min under an Ar atmosphere, and maintained at the temperature for 1 h, after that cooled to obtain 0.92 g gray-black solid fiber.

An inductively coupled plasma atomic emission spectrometer was used to measure the Ti element content in the resulting fiber, and test result was 12.2%. Result of XRD measurement showed that the resulting fiber contained crystalline phases of TiC and SiC. A transmission electron microscopy was used to analyze the fiber grain size, showing that TiC had a grain size in the range of 35-50 nm, and was dispersed in nanoscale among SiC grains, thus forming a TiC.SiC multiphase ceramic fiber.

### Example 16

A polyhafnocarbosilane (containing Hf, Si, C and H) with a softening point of 70° C., a molecular weight of 1400 and a molecular weight distribution of 1.2 was added into a melt spinning tank, melted at 200° C., maintained at constant temperature for 6 h, defoamed, and then cooled to 100° C., after that pressurized to 0.5 MPa with nitrogen gas, spun on a spinning machine, and a raw fiber was obtained at a filament collecting speed of 3 m/s, the resulting raw fiber had a diameter of about 12 microns. 2 g thus obtained raw fiber was subjected to aging at 140° C. under oxygen gas for 40 min, then raised to 1600° C. at a heating rate of 2° C./min under an Ar atmosphere, and maintained at the temperature for 1 h, after that cooled to obtain about 1.35 g gray-black solid fiber.

An inductively coupled plasma atomic emission spectrometer was used to measure the Hf element content in the resulting fiber, and test result was 25.2%. Result of XRD measurement showed that the resulting fiber contained crystalline phases of HfC and SiC. A transmission electron microscopy was used to analyze the fiber grain size, showing that HfC had a grain size in the range of 50-150 nm, and was dispersed in nanoscale among SiC grains, thus forming a HfC.SiC multiphase ceramic fiber.

As can be seen from the above examples, in the preparation of raw fiber by melt spinning method, spinning temperature and aging temperature are between 110-200° C., much lower than the spinning temperature and aging temperature of polycarbosilane. Also, polymetallocarbosilanes containing different metal elements/polyborazine can be used as raw materials to obtain a multicomponent multiphase ceramic fiber formed by combination of MC and/or MB₂ with SiC.

The resulting ZrC, TiC, HfC and ZrB₂ can form a nanoscale dispersed binary or ternary multiphase ceramic fiber with SiC. As heat treatment temperature is raised, nano-grains in the fiber grow. Yet because of the mutual suppression of various components that are dispersively distributed in nano-scale, when the heat treatment temperature is 1600° C., ceramic grains in the fiber are still in nano-scale, therefore it is possible to effectively improve the resistance of fiber to high temperature creep and ensure little change in the mechanical properties of fiber. Interface between MC/MB₂ and SiC has no significant orientation, and a multiphase ceramic formed from such an interfacial structure is in favour of improving the high temperature mechanical properties of the ceramic fiber.

Meanwhile, since a synthetic polymetallocarbosilane is used as a raw material, even though the mass percent of Ti, Zr or Hf element in the fiber is greater than 3%, various metal ceramic phases can still be uniformly dispersed in the SiC phase, and defects of uneven performances caused by local aggregation of a metal ceramic phase will not occur.

The multiphase ceramic fiber prepared according to the present invention has excellent high-temperature resistance and oxidation resistance, and remains stable in mechanical properties at 2200° C. The multiphase ceramic fiber of the present invention can be used as a reinforcement for preparing a ceramic fiber reinforced composite.

Additionally, as polymetallocarbosilane of the present invention has excellent solubility in a non-polar solvent (benzene-based solvent), it can easily get into a carbon fiber (C_{f}) or silicon carbide fiber preform by way of liquid phase impregnation, and upon high temperature pyrolysis, a carbon fiber or silicon carbide fiber reinforced multiphase ceramic-based composite is formed, the usage temperature and oxidation resistance for such a multiphase ceramic-based composite will be significantly higher than for the existing C_{f}/C or C_{f}/SiC composite.

1. A polymetallocarbosilane, having the following structural formula: 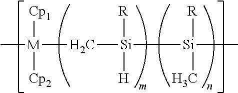
Wherein, R is methyl, ethyl, propyl, ethenyl, chloromethyl, phenyl or phenethyl; M is Ti, Zr or Hf; m is an integer equal to or greater than 1, n is an integer equal to or greater than 0, and Cp₁ and Cp₂ are each a cyclopentadienyl or substituted cyclopentadienyl group.

2. The polymetallocarbosilane according to claim 1, having the following structural formula: 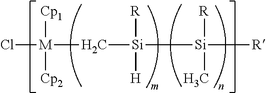
Wherein R′ is Cl, CH₂-MCp₁Cp₂Cl, Si(Me)₃, CH₃, C₂H₅, OH, OCH₃ or OC₂H₅.

3. A method for preparing the polymetallocarbosilane according to claim 1, comprising the steps of:
(1) Adding reactant 1 and reactant 2 in proportion to an organic solvent, and adding reactant 3 dropwise to the reaction system at a reaction temperature of 0-160° C., allowing to react sufficiently until the reaction system is neutral, and cooling to room temperature;
(2) Removing precipitate from the reaction system to obtain a solution G, and removing solvent from the solution G to obtain said polymetallocarbosilane;
Wherein, in step (1), the reactant 1 is a bis(cyclopentadienyl) M dichloride or bis(substituted cyclopentadienyl) M dichloride, M is Ti, Zr or Hf, and the reactant 2 is an alkali metal, the organic solvent is a non-polar solvent, and the reactant 3 has the following structural formula:
SiR¹R²Cl₂
Wherein, R¹ is methyl; R² is methyl, ethyl, propyl, ethenyl, chloromethyl, phenyl or phenethyl;
Wherein, the material amount ratio of the reactant 1 to the reactant 3 is 1:50 to 1:1, the ratio of material amount of the reactant 2 to material amount of Cl contained in the reactant 1 and the reactant 3 in total is 1-1.25, and the mass of the organic solvent is 3-10 times that of the reactant 3;
Wherein, steps (1) and (2) are both carried out under an anhydrous oxygen-free condition with inert gas protection.

4. The method according to claim 3, wherein the ratio of material amount of the reactant 2 to material amount of Cl contained in the reactant 1 and the reactant 3 in total is 1-1.1.

5. The method according to claim 3, wherein said reaction temperature is 90-110° C.

6. The method according to claim 3, wherein said non-polar solvent is toluene or xylene.

7. The method according to claim 3, wherein said alkali metal is sodium, potassium or sodium-potassium alloy.

8. The method according to claim 3, wherein said inert gas is nitrogen or argon.

9. A composite carbide or multiphase ceramic fiber, which is prepared from the polymetallocarbosilane of claim 1 as a raw material.

10. The composite carbide or multiphase ceramic fiber according to claim 9, wherein the composite carbide is prepared by the step of:
Using said polymetallocarbosilane as a precursor and performing heat treatment at high temperature above 1100° C. with inert gas protection, thus obtaining a SiC.MC composite carbide.

11. The composite carbide or multiphase ceramic fiber according to claim 10, wherein process conditions for the heat treatment are that heating rate being 1-5° C./min, heat treatment temperature being 1100-1600° C., and maintaining at the temperature for 1-4 hours.

12. The composite carbide or multiphase ceramic fiber according to claim 9, wherein the multiphase ceramic fiber component contains SiC and MC and/or MB₂, and SiC and MC and/or MB₂ are uniformly and dispersively distributed.

13. The composite carbide or multiphase ceramic fiber according to claim 12, wherein SiC is a continuous phase, and MC and/or MB₂ is dispersed in the continuous phase of SiC with a particle size of 2-200 nm.

14. The composite carbide or multiphase ceramic fiber according to claim 13, wherein the particle size of MC and/or MB₂ is 2-50 nm.

15. The composite carbide or multiphase ceramic fiber according to claim 12, wherein M represents a mass fraction of 3%-30% in the entirety of the multiphase ceramic fiber.
